(19) United States
(12) Patent Application Publication
(10) Pub. No.: US 2010/0324952 A1
(43) Pub. Date: Dec. 23, 2010

(54) CONTINUOUS GOVERNANCE, RISK AND COMPLIANCE MANAGEMENT

(76) Inventors: Alberto Mourao Bastos, Rio De Janeiro (BR); Alvaro de Silva Lima Filho, Rio de Janeiro (BR); Joao Fernando Nery de Oliveira, Rio de Janeiro (BR)

Correspondence Address: F. CHAU & ASSOCIATES, LLC, 130 WOODBURY ROAD, WOODBURY, NY, 11797, US

(21) Appl. No.: 12/518,082

(22) PCT Filed: Dec. 5, 2007
(86) PCT No.: PCT/IB07/04656

§ 371 Date: Jun. 5, 2009

Related U.S. Application Data
(60) Provisional application No. 60/868,663, filed on Dec. 5, 2006.

(51) Int. Cl. G06Q 10/00; G06Q 99/00

(52) U.S. Cl. 705/7; 705/317

(57) ABSTRACT

A method for managing Governance, Risk and Compliance (GRC) within an integrated framework includes inventorying assets and relationships with business components of an organization structure (101), determining risk and compliance indexes for at least each asset and business component (102), evaluating the risk and compliance indexes for GRC decisions (103), and determining and managing a treatment process based on an evaluation of the risk and compliance indexes (104).

### CROSS-REFERENCE TO RELATED APPLICATION

This application claims the benefit of U.S. Provisional Application Ser. No. 60/868,663 filed Dec. 5, 2006, the disclosure of which is hereby incorporated by reference in its entirety.

### BACKGROUND OF THE INVENTION

1. Technical Field

The present invention relates generally to governance, risk, and compliance (GRC) management, and more particularly to creating a common framework and a structured approach for GRC management in organizations from diverse sectors comprising technological and non-technological assets and contexts.

2. Discussion of Related Art

As organizations face a range of risks that may affect their objectives and business continuity, they increasingly need better risk management (R) in order to improve corporate governance (G), and compliance (C) with regulations. Current technologies for managing governance, risk and compliance processes are departmental. These processes may not integrate or communication across lines of business.

Further, assessments of GRC are typically performed periodically for measuring the risk levels to which the organizations are exposed before irreparable damage occurs. Risk assessment allows identifying, analyzing, and evaluating the risks, considering their potential effects to the organization objectives, and deciding about risk treatment and appropriate priorities. Risk management also includes the [symbol] besides of continuously monitoring and review. However, periodic assessments can leave gaps in knowledge.

Therefore, a need exists for a system and method for a common framework and a structured approach for continuous GRC management.

### SUMMARY OF THE INVENTION

A method for managing Governance, Risk and Compliance (GRC) within an integrated framework includes inventorying assets and relationships with business components of an organization structure, determining risk and compliance indexes for at least each asset and business component, evaluating the risk and compliance indexes for GRC decisions, and determining and managing a treatment process based on an evaluation of the risk and compliance indexes.

The method may include outputting a report including at least one requirement and an indication of compliance with the at least one requirement. The report further includes a status of a control on the at least one requirement.

Inventorying includes dividing the organization structure into perimeters, each perimeter having at least one asset, and each asset having at least one asset component, and populating the risk and compliance indexes through the organization structure, wherein related perimeters, assets, and asset components automatically inherit risk and compliance.

The method may include associating the organization structure with at least one process, associating the at least one process with at least one asset, and displaying the organization structure, the at least one process and the at least one asset in a hierarchical graph of nodes, wherein each node is displayed with a respective ones of the risk and compliance indexes.

The risk index may be determined for [symbol] severity, and a relevance. The method may include associating an action with a predetermined value of the risk estimation.

The compliance index may be determined by dividing a quantity of all controls found as implemented by an amount of a quantity of applicable controls considered.

Determining and managing the treatment process may include determining a responsible stakeholder, and tracking activity affecting the risk and compliance indexes.

The method may include determining risk and compliance indexes for perimeters, wherein each perimeter is a consolidation of two or more of the indexes.

A system for managing Governance, Risk and Compliance (GRC) within an integrated framework includes a memory device storing a plurality of instructions embodying the system for managing Governance, Risk and Compliance (GRC) within an integrated framework, and a processor for executing the plurality of instructions to perform a method including receiving an inventory of assets and relationships with business components of an organization structure, determining risk and compliance indexes for at least each asset and business component, evaluating the risk and compliance indexes for GRC decisions, and determining and managing a treatment process.

The system may output a report including at least one requirement and an indication of compliance with the at least one requirement. The report further includes a status of a control on the at least one requirement.

Inventorying may include dividing the organization structure into perimeters, each perimeter having at least one asset, and each asset having at least one asset component, and populating the risk index through the organization structure, wherein related perimeters, assets, and asset components automatically inherit risk.

The system associates the organization [symbol] the at least one process with at least one asset, and displays the organization structure, the at least one process and the at least one asset in a hierarchical graph of nodes, wherein each node is displayed with a respective ones of the risk and compliance indexes.

The risk index may be determined for each control as a function of a probability, a severity, and a relevance. The system associates an action with a predetermined value of the risk estimation.

The compliance index is determined by dividing a quantity of all controls found as implemented by an amount of a quantity of applicable controls considered.

The system may create a questionnaire for collecting information creating the inventory of assets and relationships with business components of the organization structure.

The system may include a communication connection to the assets, wherein information for creating the inventory of assets and relationships with business components of the organization structure is automatically collected over the communication connection.

### BRIEF OF DESCRIPTION OF THE DRAWINGS

Preferred embodiments of the present disclosure will be described below in more detail, with reference to the accompanying drawings:

FIG. 1 is a view of the GRC management framework according to an exemplary embodiment of the present disclosure;

FIG. 2 is a view of the relationships among risks (GRC requirements) and the elements handled by the system (Organization Inventory) according to an exemplary embodiment of the present disclosure;

FIG. 3 is a display showing a governa [symbol] with the relationship between assets and business components layers of the organization (inventory) according to an exemplary embodiment of the present disclosure;

FIG. 4 is a display illustrating the metaframework approach according to an exemplary embodiment of the present disclosure;

FIG. 5 is a display showing part of compliance report generated by the compliance module according to an exemplary embodiment of the present disclosure;

FIG. 6 is a display showing how risks are calculated and consolidated using different layers and visions (according to PSR calculation) according to an exemplary embodiment of the present disclosure;

FIG. 7 illustrates how the Business Continuity Plan module allows creating different types of business continuity plans related to Functional Structure of the organization (Inventory), classified in terms of Business Impact Analysis—BIA with criticality and others attributes according to an exemplary embodiment of the present disclosure; and

FIG. 8 is a diagram of a system according to an embodiment of the present disclosure.

### DETAILED DESCRIPTION OF EXEMPLARY EMBODIMENTS

According to an embodiment of the present disclosure, governance, risk and compliance (GRC) in organizations is managed through a common framework for continuously managing technological and non-technological assets and contexts.

To facilitate managing GRC within organizations, the common framework and processes use a metaframework structure and set of knowledge bases of controls. The common framework allows organizations to manage technology-related risks (e.g., information security, IT governance, technologic audits) as well as non-technological ones (e.g., vendor assessments, operational risk, S [symbol] addition, the common framework provides a risk management methodology, which includes organizing information in a structured way, facilitating decision-making and the prioritization of GRC initiatives. The process of managing risks and compliance treatment is tracked and facilitated by the use of the integrated workflow management feature.

Exemplary benefits for organizations of the system include: (i) optimization of GRC planning and management, (ii) automatic creation of statistical reports containing tables and graphs, (iii) analysis performed using integrated processes and methods available on the system, (iv) integrated analysis encompassing technology, processes and people made possible by knowledge bases covering multi-platform controls, (v) a continuously updated knowledge base, compliance with the requirements needed for most known frameworks (ISO 27001, COBIT 4.1, ISO 17799, ISO 27002, PCI-DSS1.0 and 1.1, FISAP/AUP 2.0, HIPAA, NIST 800-53, FISMA, ITIL, A130, DOD 8500.2, etc.), (vi) staff training through technology transfer of the system knowledge base, (vi) tracking asset risk evolution on several of the organization's perimeters, by means of risk and compliance indexes, (vii) integrated risk assessment methodology using unique method to calculate risks, using the same approach, independently of the type of asset that is being examined (technology, process, people, and facilities), (viii) support for the creation of action and treatment plans by prioritizing initiatives according to risk and other system indexes, (ix) checking compliance with legal requirements, GRC standards and any other document containing specifically binding clauses, and (x) the formal involvement of stakeholders and responsible for treatment and management.

The structured approach to GRC management, offers a base upon which management can make a decision and obtain answers to questions such as: Which are the main risks from the business standpoint? Which are the existing controls, policies and vulnerabilities? What are the current risk levels to which assets and [symbol] the recommendations for managing risks? How can we determine and implement Governance and controls? How can we justify and prioritize the investments in GRC? How can the risks be presented to the users and to the top management? How can I follow up and manage risk treatment process across enterprise?

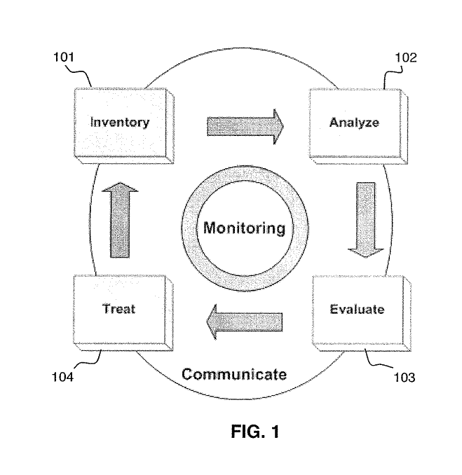

Referring to FIG. 1, an integrated framework is implemented to address the GRC process including: (i) Inventory 101—to inventory assets including people, technology, facilities and processes, and their relationships with business components; (ii) Analyze 102—to analyze and obtain risk and compliance indexes for GRC management; (iii) Evaluate 103—to evaluate risks and compliance indexes for GRC decisions; and (iv) Treatment 104—to control and manage the treatment process, involving responsibility definitions, following-up and tracking the activities, etc. This conceptual scheme applies to system modules and GRC processes.

According to an exemplary embodiment of the present disclosure, one or more of the following modules may be implemented in a common framework according to an embodiment of the present disclosure: organization, analysis, questionnaires, evaluation, compliance, business continuity, workflow manager and reports.

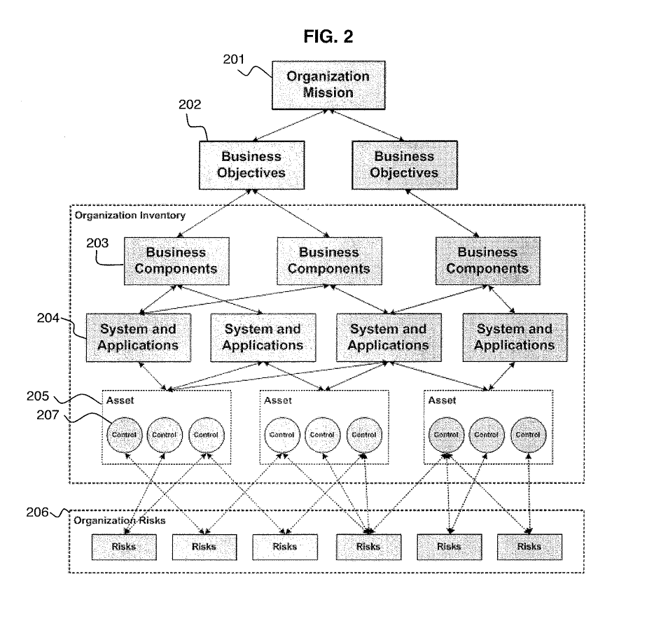

The organization module (see FIG. 2) addresses the inventory phase 101 and allows for the making of an inventory of assets in a structured way inside of organization branches, and defining responsibilities for each one. At the same time, assets may be connected to business components and systems/applications common framework in order to facilitate the risk results reading across the organization. Assets and perimeter meta-attributes can be created including one or more of the following: Short text; Long text; Integer; Real; Yes/No; Date; Combo list; Multi-choice list; and File. The file meta-attribute allows for the insertion of a file (e.g., document or image) for each asset presented in the inventory. This feature enables classification and grouping of the inv [symbol] module.

Each asset encompasses one or more assets components, related to a specific knowledge base of controls and policies to evaluate its risks. The knowledge base can be created by system users or imported from standards knowledge bases created by organizations and used together with proprietary knowledge bases. The assessment is performed by means of projects and respects the best practices for project management. The results and indexes are automatically updated in the organization module, allowing following up the organization GRC status.

The analysis module 102 allows a scope to be defined by selecting part of the organization (perimeters and/or assets) and allows analysis of risk and compliance by using the knowledge bases related to their asset components. For each analysis project, is possible to define the responsible for the analysis, follow-up and control the overall project execution

The evaluation module 103 allows for the selection of risks and compliance to be managed by creating actions for treatment 104, and establishing responsibilities for individuals across the organizations. Once the risks and compliance are assessed, the treatment module 104 acts as a workflow system to support activities tracking and follows up events and the current status.

In order to keep the business running, companies must be prepared for event scenarios that jeopardize the organization objectives (risks). A business continuity plan (BCP) module is integrated with organization module and helps to create and maintain versioned plans to inventoried assets (business recovery plan) and business processes (business continuity and resumption plan) and can be stored, updated, and recovered when needed.

The compliance module is used for evaluating the compliance level with requirements for a specific scope selected from the organization. It uses the results of the performed risk analyses using a cross-reference among the c [symbol] respective frameworks and requirements. For this purpose, the metaframework approach is used, in which each requirement is decomposed into simpler actions and related to each existing control and policy in the knowledge base. It also allows crossing the requirements to meet at the same time multiples compliance and audits. For example, simultaneous compliance with ISO 27001, COBIT 4.1, ISO 17799, ISO 27002, PCI-DSS1.0 and 1.1, FISAP/AUP 2.0, HIPAA, NIST 800-53, FISMA, ITIL, A130, DOD 8500.2, and others. Others frameworks and requirements can be included. The system presents automatically the cross-reference among policies, frameworks requirements and controls.

The reports module encompasses graphics, documents, maps and tables. Reports can be customized and generated for the entire organization, projects, or for specific business components, branches, perimeters or assets.

FIG. 2 describes relationships among risks (GRC requirements) and the elements handled by the system (organization inventory). FIG. 2 is a view of the relationships among risks (GRC requirements) and the elements handled by the system (organization inventory). Organization mission 201 is described in terms of business objectives 202, and supported by the related business components 203 (functions and process), system and applications 204 and assets 205 (people, process, facilities and technology). At the bottom, risks 206 are linked with the respective controls 207.

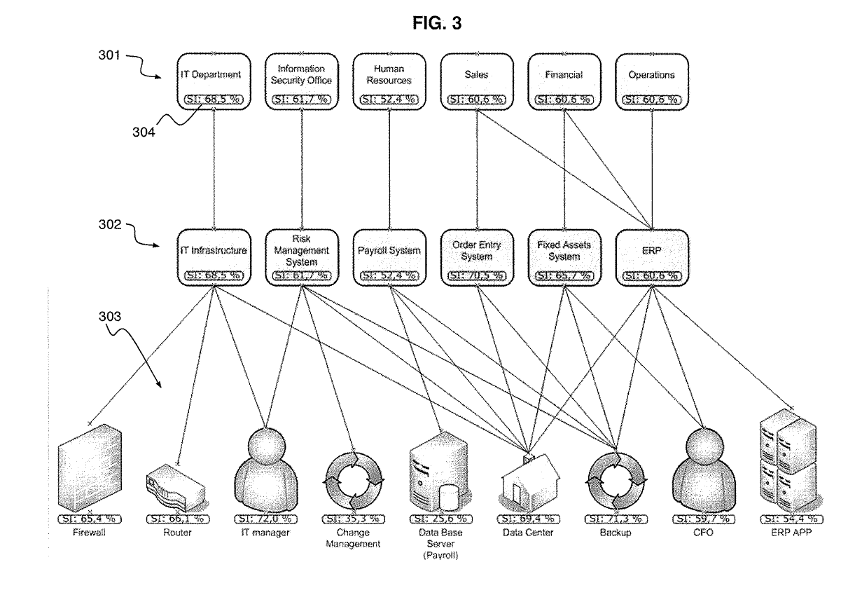

In an inventory phase 101 the organization structure may be customized, including assets, perimeters, systems and business components. Each organization is divided in branches or perimeters, and each perimeter has assets, and each asset has asset components. Perimeters are, for example, a consolidation of indexes at a geographic location, such that a sum of risk an compliance may be determined for the perimeter. One of ordinary skill in the art would recognize that a perimeter may be a consolidation of any indexes, and is not limited to consolidations by geography. Time, assets [symbol] through systems/applications and business processes may also be customized. Once the asset is at risk, consequently the related perimeters, system, and business components inherit these risks. FIG. 3 illustrates risk and compliance consolidation and inheritance via an exemplary report.

Referring to FIG. 3, business or groups within an organization 301 are associated with one or more processes 302. Each of the processes 302 are associated with one or more assets 303 (e.g., technological and non-technological assets). Each block within the report of FIG. 3 includes a status bar and percentage 304, e.g., revealing compliance or risk indexes. For example, for the IT department, the department is 68.5% at risk as shown in the status bar. This is the same score of IT Infrastructure (68.5%) that supports the IT department. And this score was calculated based on risk indexes of respective assets associated (e.g., Firewall, Router, IT Manager and Datacenter).

Exemplary system modules include: organization, analysis, questionnaires, evaluation, compliance, business continuity, workflow manager and reports. In an exemplary software implementation, the organization structure (inventory 101) can be input in a modular way organized in perimeters (and sub perimeters), assets and assets components 102. By using perimeters, assets 102 can be grouped by different visions (e.g., OS, application, network segment, etc). Each asset component is associated with a knowledge base containing the related information for GRC requirements (assessment). The interface to create assets components is context sensitive, and shows only knowledge bases related to the respective asset type, following the knowledge base taxonomy. The perimeter risk and compliance status can also be viewed in a status tab (monitor). Within the exemplary software implementation, a managers tab allows one to define manager's access credentials for the current perimeter. The system can handle mul [symbol] structure and properties.

The system implements rights and credentials for accessing knowledge bases files and use of the off-line application. Data used in database tables can be encrypted, together with imported or exported questionnaires. In this case of exported knowledge bases, only defined users can access the answers and questions of the questionnaire.

The input of assets and branches (or perimeters) may include, in addition to others assets and perimeters fields, Latitude and Longitude coordinates and others customized attributes for assets and perimeters in a particular organization. The attributes can be also collected by automated collectors and questionnaires sent to users. The perimeter status can also be viewed in the status tab. The managers tab is the place to define manager's access credentials for the current perimeter. An agents tab is where, for each organization, risk agents can be associated with the threats that are being considered for GRC requirements to the organization.

The exemplary software implementation may further accept property fields, status and analysis history. The properties fields reveal relevance, criticality, and analysis frequency and also how the assets relate to business components and systems/applications. In addition, the system allow for other customized attributes for asset types. The attributes can be also collected by automated collectors and questionnaires sent to users. The asset risk and compliance status can also be viewed in the status tab. The analysis history tab shows the risk analysis history for the current asset. A display page of the attributes definition reveals asset and perimeters attribute types including, for example, short text; long text; integer; real; yes/no; date; combo list; multi-choice list; and file. Relations between assets, systems/applications or processes, and business components, with their respective relevance and criticality may be displayed.

The organization risk status may be pr [symbol] their respective indexes such as security and compliance indexes, as well the last analysis date and expiration date. For example, the responsible party for each perimeter can follow up risks and compliance regarding the assets under his accountability. Here, a new analysis is completed for assets under his accountability the risk indexes update automatically.

Related to inventory phase 101, an integration console feature enables one to fulfill inventory from different sources, for example, to export and import inventory, assets, users by using XML files, spreadsheets or direct connection to Active Directory or other system/applications. The software can import assets directly from Microsoft Active Directory or other directory systems, from spreadsheets or from XML files.

Referring to the analysis phase 102, project analysis includes creating and defining the responsible party for each asset component analysis. The system allows analysts to perform analysis remotely. By using the off-line application and distributed agents and automatic collectors, users can analyze target assets in remote locations. The analysis process encompasses a sort of activities, as follows: defining analysts in charge, exporting questionnaire knowledge bases, perform analysis, and import filled questionnaires. Current knowledge bases can be stored for future comparisons to new or updated knowledge bases, for example, for tracking, historic and audit purposes.

An exemplary analysis project may be displayed including a scope tab allowing for the selection of a scope of a functional structure to be analyzed in the project. For each selected asset component, the system creates a copy of the chosen knowledge base version (snapshot) to be answered in the project, using the questionnaire or by automated process.

The management of an analysis project includes presenting for each asset and assets component respective responsible, analysis status, PSR level, and other attributes. Using export and import functionality, the questionnaire can also be sent and used by offline application remotely (using handheld devices [symbol] questionnaire answer can also be scheduled and automated by using the distributed multiple collectors.

A questionnaire includes a set of controls to be analyzed. For each control, the status is answered and probability and severity variables can be adjusted for the environment. A comment field may be used to add more information regarding the context of the control under verification. A status bar shows the consolidation of the answers. The questionnaire is able to filter controls according to a customizable view or profile. In a questionnaire detail tab, a set of applicable controls and its knowledge base are displayed. For each control the specific information are shown such as rationale, recommendation, references, threats (potential risks), etc.

Each control has its own attributes with information that helps risk and compliance assessment including, for example, control name, rationale, recommendations, references, and threats (one or more), probability and severity. Knowledge bases have the same structure, allowing for analysis and evaluation of different risks by using the same estimation criteria, allowing companies to prioritize actions and take decisions about risk and compliance treatment.

The analysts (responsible parties) interact with the system to perform each asset component analysis. The knowledge and automation for each analysis is incorporated into the knowledge base. The knowledge is substantiated in each control details: rationale, recommendation, references, threats, probability, and severity. To reduce the time and cost to perform analysis in different type of assets, the system apply different approaches. For technological assets the system includes automatic evidence collectors such as programs and scripts for collecting evidences locally or remotely to gather information about system configurations, and with automatic scripts to interpret evidence and determine/answer the controls status. For process and people asset types, on-line and Web inter [symbol] information about behaviors and procedures, and with automatic scripts containing a logic of how to interpret the evidence and answer the controls status. For example, it allows performing the user's assessment by means of web interview. In addition, the system also allows analysts to insert digital evidence which will be stored in the system. All evidence collected is stored in a centralized database and used to support knowledge base answering by means of specific logical interpretation.

Referring again to the questionnaire, evidence digital files may be attached for each control under analysis (digital photos and other documents files). Other tabs and evidences can be imported by the system, such as vulnerability data and other information through integration with systems and applications (such as vulnerability scanners, intrusion detection systems, intrusion protection systems, etc.).

Evidence is collected and automatically interpreted for answering controls in technological assets (for instance, MS Windows XP Pro Operating system). The system can also schedules and automates this process using the distributed multiple collectors.

Users can create their own knowledge base with policies and controls to be used during the analysis. There are two steps for developing new knowledge bases, the first step is to create policies and controls using the knowledge base editor, and the second step is to activate this knowledge base for production usage (to be used in future assessments). In order to allow different versions of customized knowledge base, the system implements a version control. A knowledge base editor allows for the creation of a knowledge base of customized controls, policies and respective attributes. The system can also import database contents by using XLS and XML files. Version management for knowledge bases may also be implemented. The system controls version of knowledge bases by defining a new version for each update. The old versions are kept availa [symbol] the system implements a database cleaning of unused knowledge bases.

Email may be incorporated into the system, for example, sent by the system with the questionnaire to be answered by users using Web questionnaires through e-mail notification. This process is called online interview and allows sending questions, policies and surveys to be answered and evaluated remotely. It also allows policy distribution and attestation of reading. Similarly, a web interface with specific questions related to the questionnaire controls and policies may be used as evidence to answer the controls status. This message could be customized for each type of questionnaires. For example, a PDA may be used for displaying the web interface.

The automatic interpretation of the questions are used as evidence to answer each control in the questionnaire.

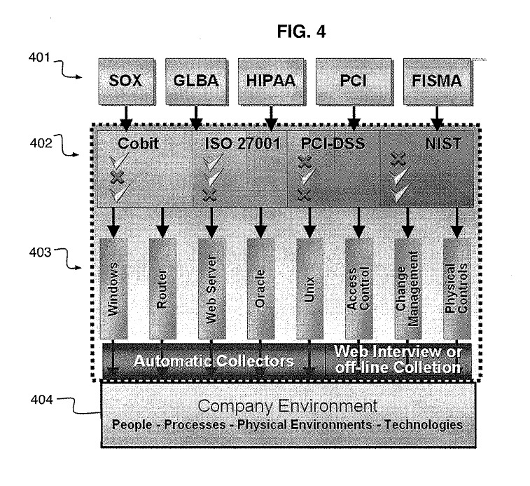

Reports can be generated automatically by users to consolidate analysis. Reports can be used in the evaluation phase 103 and the outputs can be filtered to consider one specific project or to consider the entire organization. The reports can be viewed onscreen and generated in Ms-Word, MS-Excel, MS-Visio, Google Earth and other types of format files (HTML, PDF, XML, etc.). The outputs can be filtered by assets or perimeters attributes, project, scope, business component, type of assets; knowledge bases, risk and compliance levels, and others appropriate arrangement of consolidation. Referring to FIG. 4, the metaframework approach enables dynamic filtering by business context. For example, referring to the organization map of FIG. 3, a organizations risk assessment may be filtered to reveal risk associated with particular businesses or groups within the organization such as information technology, human resources, etc. Reports that can be automatically generated by the system, based on templates that can be customized.

FIG. 4 is a display illustrating the met [symbol] structure for mapping and relating requirements, standards, policies and frameworks with the knowledge base and respective controls, connecting each assessment and assets of the organization environment with all the multiple applicable compliance requirements. In the metaframework, a set of regulations 401 are given, and to ensure compliance some well known standards and frameworks are used 402 (for example ISO 27001, COBIT 4.1, ISO 17799, ISO 27002, PCI-DSS1.0 and 1.1, FISAP/AUP 2.0, HIPAA, NIST 800-53, FISMA, ITIL, A130, DOD 8500.2, and others). By dividing these requirements and frameworks (401-402) into atomic parts 403 (actions), the requirements and frameworks (401-402) may be cross-referenced and linked with one or more controls in knowledge bases 404. Again, the metaframework concept enables each requirement 401 to be decomposed into simpler actions 403 related to each existing control and policies in the knowledge base 404. It also allows crossing the requirements to meet multiple compliance and audit needs simultaneously. For example, simultaneous compliance with ISO 27001, COBIT 4.1, ISO 17799, ISO 27002, PCI-DSS1.0 and 1.1, FISAP/AUP 2.0, HIPAA, NIST 800-53, FISMA, ITIL, A130, DOD 8500.2, and others. Others frameworks and requirements can be included. The system presents automatically the cross-reference among policies, frameworks requirements and controls.

Referring to the analysis phase 102 of the compliance module, compliance projects are defined and contextualized. The analysis phase 102 of the compliance module allows for compliance projects to be defined and contextualized. For each reference model chosen, the system allows to define maturity/capacity scales for the compliance analysis and the criteria to automate the answers.

Referring to the compliance module, the user can choose the standard (NIST in this case), and by verifying how many controls are in place for control objectives (actions), the system helps you to adjust the compliance status for each requirement and to answer automatically the compliance level based on [symbol] compliance module allows the application of the metaframework to simultaneously evaluate the compliance level of multiple frameworks based on the performed assessments. Although the example of FIG. 4 shows compliance with NIST, ISO 17799, and COBIT, other frameworks and requirements can be included using the Context Tab, for example ISO 27001, CUBIT 4.1, ISO 17799, ISO 27002, PCI-DSS, FISAP/AUP, HIPAA, NIST 800-53, FISMA, ITIL, A130, DOD 8500.2, etc. The system presents automatically the cross-reference among frameworks requirements, policies and controls.

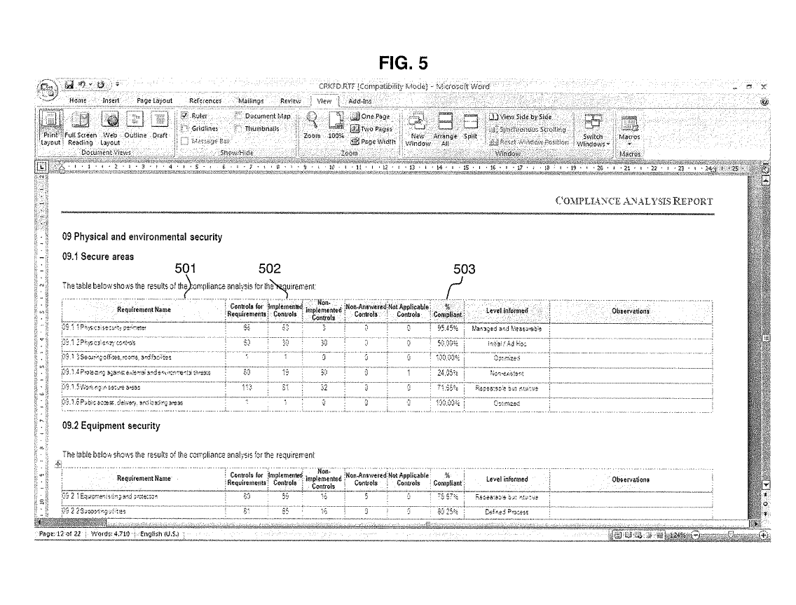

FIG. 5 is a display of the compliance report generated automatically after compliance analysis, e.g., by the compliance module. Requirements 501 are given together with the number of associated controls 502 and their status, e.g., implemented, non-implemented, non-answered, not applicable. A level of compliance 503 is also displayed.

Outputs generated by the users consolidate the analysis. These outputs can be filtered by different ways and to consider one specific project or to consider the entire organization.

FIG. 3 is a display showing a governance view automatically generated by the system with the relationship between assets 303 and business components layers 301-302 of the organization (inventory). The relevance of the assets is calculated based on the relevance of the supported business components. The risk and compliance indexes of the business components are calculated considering all the risks and compliance indexes of the assets that support it. This view can be filtered by selecting one or more assets, business components or customized attributes.

Geo-referential risk and compliance views can be automatically generated by the system with the consolidation of the risk and compliance indexes per asset in each perimeter. The consolidation can be presented using colors to identify the overall risk and compliance levels in each perimeter (see for example, 304 of FIG. 3).

A risk scorecard, e.g., FIG. 5, is auto [symbol] different kinds of consolidation for the risk and compliance indexes in a single page. The report can be customized using for example pie charts, bar charts, tables, scores and other consolidation options. The output can be filtered by selecting one or more assets, business components, and customized attributes

A main conclusions section of the risk analysis report is automatically generated by the system, presenting the summary of the main indexes in the considered scope. The consolidations include quantitative and qualitative indexes, based on the number of applicable controls with its respective risk and compliance levels, and considering if it is implemented or not implemented. The report can be filtered by selecting perimeters and assets, business components, type of assets, levels of risk and compliance, customized attributes and others filters.

A consolidated risk analysis section of the risk analysis report is automatically generated by the system, presenting the summary of the risks. The consolidations include quantitative and qualitative indexes, based on the relevance of the business component and the respective number of applicable controls and risk and compliance levels. The report can be filtered by selecting perimeters and assets, business components, type of assets, levels of risk and compliance, customized attributes and others filters.

A risk class distribution by asset type section of the risk analysis report is automatically generated by the system, presenting the summary of the risks. The consolidations include quantitative and qualitative indexes classified by asset type and risk and compliance levels. The report can be filtered by selecting perimeters and assets, business components, type of assets, levels of risk, customized attributes and others filters

A detailed risk report is automatically generated by the system, presenting for each control, the respective status, risk level, detailed information, and related asset. The report can be filtered by selecting perimeters and as [symbol] control status, minimum level of risk, customized attributes and others filters.

The evaluation module outputs a prioritized list of risks and compliance with their respective status. Based on the risk criteria, the user can make a decision about the acceptance or treatment actions. Referring to FIG. 1, this module is part of the evaluation phase 103. Using the evaluation module 103 with a prioritized list of risks and their respective status, based on the risk criteria, the user can make a decision about the acceptance or treatment actions. In case of acceptance, users can justify or attach approval evidence.

An action plan may be created to treat risks and compliance. The actions are followed up in the Workflow Manager module, and can be monitored using the status field (Treated, untreated, task created, accepted, etc.).

A workflow manager allows one to track and manage issues and events. A list of events comes from the evaluation module 103 and also from others sources, such as web interface and integration with agents, systems and applications, through specific API. The system can handle any kind of issues or events that demands follow up and tracking, such as incident response, support ticketing, remediation and exception plans change management, etc. The workflow manager may show the follow up of an event status/progress that includes activities registration, changing priority, insertion of evidences, and alerts and other customized attributes. Alerts can be sent via e-mail, SMS or integrated in other system/applications. The workflow manager may show the most prioritized events to be followed up, for example, the top ten. This prioritization can be customized using formulas and specific metrics from an organization.

A system users edition implements different types of users: for example, a security officer who has the administration rights; a manager who can manage one or more perimeters of the organization; and an analyst who uses the questionnaire module to answer one or more knowledge bases under his responsibilities. It [symbol] limited rights as auditors, process managers and asset or business components owners; any user can be made responsible for a project. Groups can also be created in order to group users with the same access credentials, or same functional areas or user forums.

Knowledge base management may be implemented, where for example, a table of the available knowledge base in production is shown. A table of the knowledge bases under development may also be displayed. Each knowledge base contains a version number to be applied during the analysis. Users can create its own knowledge bases, allowing organizations to use external authors for knowledge base development, called knowledge providers. A table of threats and risks descriptions may be displayed for each organization with customized threats, risks and respective agents, and a relevance according to each organization concerns. For the system, one or more risks can effect one or more assets and consequently related business components.

According to an embodiment of the present disclosure, a credit loader tracks system usage based on credits—an integer number that, according to defined rules, allows enabling system functions and the use and application of the knowledge base. The amount of credits is inserted by a challenge-response process, performed manually or automatically using web services. The available credits decrease when one or more above mentioned actions are performed, such as when generating questionnaires to be answered, enabling system modules, functions, users and frameworks.

According to an embodiment of the present disclosure, system configuration can includes password policy configuration, knowledge base live update, etc. This process allows updating the knowledge base adding new knowledge base or updated versions of existing knowledge base. This process can be performed manually or automatically using web services and scheduling the update. The same process is applicable to update the application components, its modules, programs, and temp [symbol] and statistics that can be used to generate benchmarking. The system allows customizing rules to create usernames and passwords—username and password length, account lockout and expiration. For the knowledge base live update, updating the knowledge base includes adding new knowledge bases or updated versions of existing knowledge bases. This process can be performed manually or automatically using web services and scheduling the update. The same process is applicable to update the application components, its modules, programs, frameworks and templates. The system allows sending information and statistics that can be used to generate benchmarking. For risk and compliance indexes levels, the system allows customizing the several parameters to calculate the system indexes, including ranges, descriptions, grades, criteria, sign colors, and etc. For index levels, the system allows customizing the several parameters to calculate the system indexes, including ranges, descriptions, grades, criteria, sign colors, and etc.

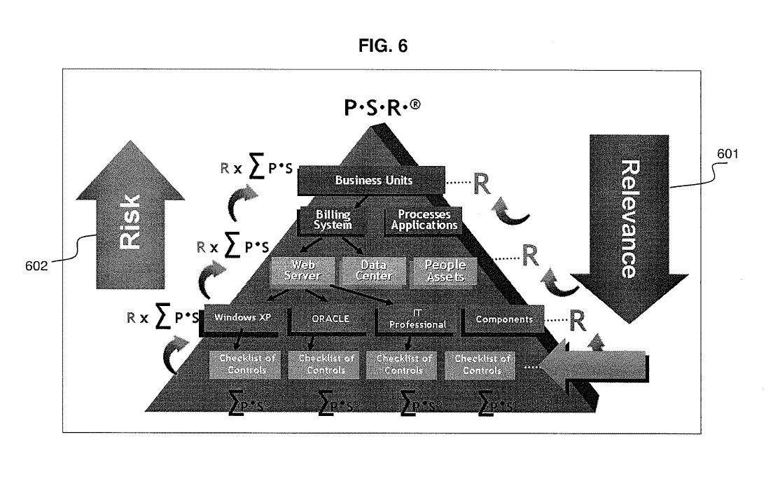

FIG. 6 illustrates an exemplary calculation of risks and consolidation using different layers and visions (according to PSR calculation). The relevance 601 of the assets is defined based on the relevance of the business components they support in their respective upper layers. Existing risks 602 in lower layers are assigned to their respective upper elements. 17. The risk estimation for each control is obtained by multiplying three factors: probability, severity, and relevance (or PSR). The probability and severity are related to each control, pre-defined in the knowledge base when it is created and can be adjusted during the analysis. The relevance comes from the asset, and it is an asset property based on its importance for the organization business components. These three factors vary from 1 to 5, and by using the following criteria: 1-Very Low, 2-Low, 3-Medium, 4-High, or 5-Very High. For each control, the risk level is obtained by the multiplication of these three factors—Risk equals to Probability times Severity times Relevance (R=P×S×R).

The following criteria are exemplary f [symbol] risk is considered very low, from 8 to 16, the risk is considered low, from 18 to 30, the risk is considered medium, from 32 to 50, the risk is considered high, and from 60 to 125, the risk is considered very high. For each risk level, an appropriate action can be associated: for very high risk level the system suggests “These are unacceptable risks and asset managers must eradicate them promptly”, for high risk level the system suggests “These are unacceptable risks and the asset managers must, at least, curb them”, for medium risk level the system suggests “These are risks that may be acceptable according to asset managers appraisal. However, the acceptance of such risks must be confirmed through formal channels”, for low risk level the system suggests “These are risks that may be acceptable according to asset managers' appraisal.”, and for very low risk level the system suggests “These are acceptable risks and should be reported to the asset managers.”

The risk index is calculated by dividing the risk results of all controls found as not implemented by the amount of the risk of the applicable controls considered in the assessment. The complement of risk index is called security index. The system allows users to customize levels of acceptable risk index. The formula for risk index is: risk index=Σ risk level of non-implemented controls/Σ risk level of applicable controls. The formula for security index is: security index=Σ risk level of implemented controls/Σ risk level of applicable controls. The applicable controls are the sum of implemented and non-implemented controls.

The compliance index is calculated by dividing the quantity of all controls found as implemented by the amount of the quantity of applicable controls considered in the assessment. The complement of compliance index is called non-compliance index. The system allows users to customize levels of acceptable non-compliance index. The formula for compliance index may be given as: Compliance index=Σ Quantity of implemented controls/Σ Quantity of applicable controls. The form [symbol] compliance index=Σ quantity of non-implemented controls/Σ Quantity of applicable controls. The applicable controls are the sum of implemented and non-implemented controls.

Consolidations respect the metrics created for this specific patent method for security, risk, compliance and non-compliance indexes.

The indexes can be used and consolidated in all organization elements considered by the system, such as business components, organization branches (or perimeters), assets, assets types, and others.

Compliance and risk indexes are stored internally to promote future queries regarding risk progress in the organization as whole, or in each organization branch (or perimeters).

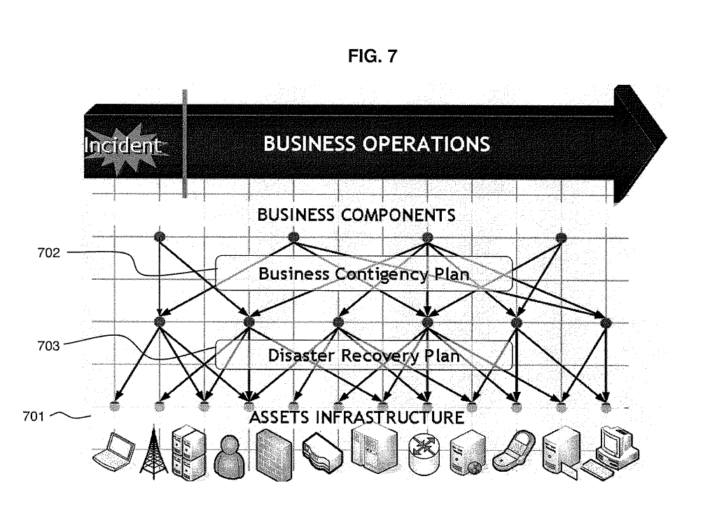

FIG. 7 illustrates the business continuity plan module, which is integrated with the organization structure 701 (inventory). The business continuity plan module 702 allows creating different types of business continuity plans related to functional structure of the organization 701 (inventory), classified in terms of business impact analysis (BIA) with criticality and others attributes. The plans can be created and managed in a modular way related to specific critical assets or business processes and structured in plans, procedures and instructions. In order to facilitate the plan maintenance, plans information is organized in tables and in case of changes is automatically updated in the documents. Some of plans information is human resources, functional groups, responsible, suppliers, facilities and contingency resources or environments. This module is fully integrated with organization inventory and others system modules.

In the BCP module, the plans are created based on the assets and business processes selected from the functional structure and can use different templates, e.g., 703, such as crisis management plan, recovery plans, operational continuity plans, resumption plans, incident response plans and other customized plans tha [symbol] needed. Also, different procedures can be stored and used in plans.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

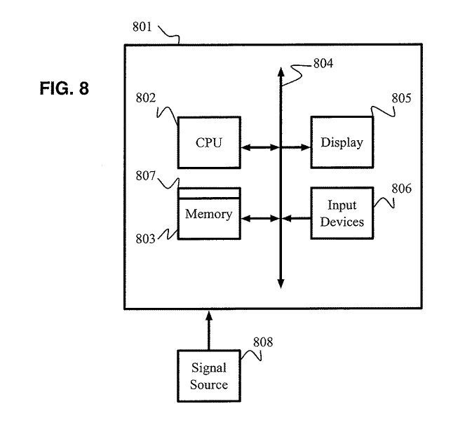

Referring to FIG. 8, according to an embodiment of the present invention, a computer system 801 for a common framework, and a structured approach for GRC management can comprise, inter alia, a central processing unit (CPU) 802, a memory 803 and an input/output (I/O) interface 804. The computer system 801 is generally coupled through the I/O interface 804 to a display 805 and various input devices 806 such as a mouse and keyboard. The support circuits can include circuits such as cache, power supplies, clock circuits, and a communications bus. The memory 803 can include random access memory (RAM), read only memory (ROM), disk drive, tape drive, etc., or a combination thereof. The present invention can be implemented as a routine 807 that is stored in memory 803 and executed by the CPU 802 to process the signal from the signal source 808. As such, the computer system 801 is a general purpose computer system that becomes a specific purpose computer system when executing the routine 807 of the present invention.

The computer platform 801 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, beca [symbol] and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described embodiments for a mechanism and method for creating a common framework, and a structured approach for GRC management, comprising technological and non-technological assets and contexts, it is noted that modifications and variations can be made by persons skilled in the art in light of the above teachings. It is therefore to be understood that changes may be made in the particular embodiments of the invention disclosed which are within the scope and spirit of the disclosure.

What is claimed is:

1. A computer readable medium embodying instructions executable by a processor to perform a method for managing Governance, Risk and Compliance (GRC) within an integrated framework, the method steps comprising:
inventorying assets and relationships with business components of an organization structure;
determining risk and compliance indexes for at least each asset and business component;
evaluating the risk and compliance indexes for GRC decisions; and
determining and managing a treatment process based on an evaluation of the risk and compliance indexes.

2. The method of claim 1, further comprising outputting a report including at least one requirement and an indication of compliance with the at least one requirement.

3. The method of claim 1, wherein the report further includes a status of a control on the at least one requirement.

4. The method of claim 1, wherein inventorying further comprises:
dividing the organization structure into perimeters, each perimeter having at least one asset, and each asset having at least one asset component; and
populating the risk index through the organization structure, wherein related perimeters, assets, and asset components automatically inherit risk.

5. The method of claim 1, further
associating the organization structure with at least one process;
associating the at least one process with at least one asset; and
displaying the organization structure, the at least one process and the at least one asset in a hierarchical graph of nodes, wherein each node is displayed with a respective ones of the risk and compliance indexes.

6. The method of claim 3, wherein the risk index is determined for each control as a function of a probability, a severity, and a relevance.

7. The method of claim 6, further comprising associating an action with a predetermined value of the risk estimation.

8. The method of claim 1, wherein determining the compliance index by dividing a quantity of all controls found as implemented by an amount of a quantity of applicable controls considered.

9. The method of claim 1, wherein determining and managing the treatment process further comprises:
determining a responsible stakeholder; and
tracking activity affecting the risk and compliance indexes.

10. The method of claim 1, further comprising determining risk and compliance indexes for perimeters, wherein each perimeter is a consolidation of two or more of the indexes.

11. A system for managing Govern [symbol] integrated framework comprising:
a memory device storing a plurality of instructions embodying the system for managing Governance, Risk and Compliance (GRC) within an integrated framework; and
a processor for executing the plurality of instructions to perform a method comprising:
receiving an inventory of assets and relationships with business components of an organization structure;
determining risk and compliance indexes for at least each asset and business component;
evaluating the risk and compliance indexes for GRC decisions; and
determining and managing a treatment process.

12. The system of claim 11, further comprising outputting a report including at least one requirement and an indication of compliance with the at least one requirement.

13. The system of claim 11, wherein the report further includes a status of a control on the at least one requirement.

14. The system of claim 11, wherein inventorying further comprises:
dividing the organization structure into perimeters, each perimeter having at least one asset, and each asset having at least one asset component; and
populating the risk index through the organization structure, wherein related perimeters, assets, and asset components automatically inherit risk.

15. The system of claim 11, wherein [symbol]
associating the organization structure with at least one process;
associating the at least one process with at least one asset;
displaying the organization structure, the at least one process and the at least one asset in a hierarchical graph of nodes, wherein each node is displayed with a respective ones of the risk and compliance indexes.

16. The system of claim 13, wherein the risk index is determined for each control as a function of a probability, a severity, and a relevance.

17. The system of claim 16, where the method includes associating an action with a predetermined value of the risk estimation.

18. The system of claim 11, wherein determining the compliance index by dividing a quantity of all controls found as implemented by an amount of a quantity of applicable controls considered.

19. The system of claim 11, wherein a questionnaire is created for collecting information creating the inventory of assets and relationships with business components of the organization structure.

20. The system of claim 11, further comprising a communication connection to the assets, wherein information for creating the inventory of assets and relationships with business components of the organization structure is automatically collected over the communication connection.
